(19) United States
(12) Patent Application Publication
(10) Pub. No.: US 2009/0019635 A1
(43) Pub. Date: Jan. 22, 2009

(54) PORTABLE SAUNA ROOM ASSEMBLY

(76) Inventor: CHING-SONG CHEN, Taichung City (TW)

Correspondence Address: LEONG C LEI, PMB # 1008, 1867 YGNACIO VALLEY ROAD, WALNUT CREEK, CA, 94598, US

(21) Appl. No.: 11/779,897

(22) Filed: Jul. 19, 2007

(51) Int. Cl. A61H 33/06

(52) U.S. Cl. 4/531; 4/524; 4/526

(57) ABSTRACT

The sauna room assembly contains a bottom frame, left and right front walls, left and right back, columns, left and right walls, a back wall a top frame, a top cover, a floor and a door. A major characteristic of the present invention is that each of the aforementioned members is in turn broken down into at least two pieces, and most members have their pieces in substantially identical dimensions. The sauna room assembly therefore can be disassembled into pieces small and standard enough for high portability. Another major characteristic of the present invention is that most of the pieces are joined together through tabling and only few bolts are required. Therefore, a single novice can put the sauna room assembly together with standard hand tools such as screwdrivers.

### BACKGROUND OF THE INVENTION

(a) Technical Field of the Invention

The present invention generally relates to sauna rooms, and more particularly to a sauna morn assembly that can be easily assembled and disassembled for superior portability.

(b) Description of the Prior Art

With increased popularity in stress reduction and regimen people have been building or considering building sauna comes in their houses. A conventional steam-based sauna room, however, has to be deliberately planned before the house is built or major reconstruction to the house would be required. These tasks have to be handled by professionals and significant costs have to be covered, in terms of not only money but also time and effort.

Recently, along with the advancement in the electrical heating technologies, electrical heating devices are already capable of producing the high temperature conventionally achievable by steam-based sauna rooms yet with greater safety and efficiency. The advent of the highly efficient electrical heating devices has made the construction of a sauna room much easier and, therefore, there are assembly-type sauna rooms such as the one shown in FIG. 13 available in the market. As illustrated, the sauna room contains a front wall with door 61, a right wall 62, a left wall 65, a back wall 64, a roof 63, a floor 66, and a seat member including components such as back rests 67, a seat 68, and a front panel 69.

As can be imagined, for a sauna room like the one shown in FIG. 13 to accommodate at least one or two adults, the aforementioned components are quite sizable and heavy (as they arts usually made of woods). To hold these components safely and reliably together, at least two persons have to work together and a significant number of bolts have to be used. In addition, a sizable pick-up truck is required to transport these components to the construction site. These overheads have significantly limited the popularity of the assembly-type sauna rooms.

### SUMMARY OF THE INVENTION

The primary purpose of the present invention is to provided herein which can be easily assembled and disassembled by as few as a single person and, when dismantled, the components can be fitted inside a standardized sedan or easy and convenient transportation.

The sauna room assembly contains a bottom frame, left and right front walls, left and right back columns, left and right walls, a back wall, a top frame, a top cover, a floor, and a door. A major characteristic of the present invention is that each of the aforementioned members is in turn broken down into at least two pieces, and most members have their pieces in substantially identical dimensions. The sauna room assembly therefore can be disassembled into these pieces that are small and standard enough for high portability. According to a real implementation, the pieces can be separated into three packages with two inside an ordinary sedan and one in the sedan's trunk.

Another major characteristic of the present invention is that most pieces are joined together enough tabling and only few bolts are required. Therefore, a single novice can put the sauna room assembly together with standard hand tools such as screwdrivers. Due to the high portability and easy construction, the sauna room assembly according to the present invention can be purchased from a store and carried directly back to the buyer's home for assembly without professional assistance. The sauna room assembly can even be mail-ordered and sent directly to the doorstep of the buyer.

The foregoing object and summary provide only a brief introduction to the present invention. To fully appreciate these and other objects of the present invention an well as the invention itself, all of which will become apparent to those skilled in the art, she following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1a is a perspective view showing a sauna room assembly according to an embodiment of the present invention.

FIG. 1b is a perspective exploded view showing the various pieces of the sauna room assembly of FIG. 1a.

FIGS. 2a and 2b are perspective views showing the assembly of the bottom frame of the sauna room assembly of FIG. 1a.

FIGS. 3a˜3d are perspective views showing the assembly of the left front wall of the area room assembly of FIG. 1a.

FIGS. 4a and 4b are perspective views showing the installation of the right front wall of the sauna room assembly of FIG. 1a.

FIGS. 5a˜5f of are perspective views showing the assembly and installation of the right back column and the right wall of the sauna room assembly of FIG. 1a.

FIGS. 6a˜6c are perspective views showing the assembly and installation of the back wall of the sauna room assembly of FIG. 1a.

FIGS. 7a and 7b are perspective views showing the assembly and installation of the top frame of the sauna room assembly of FIG. 1a.

FIG. 8 is a perspective view showing the assembly and installation of the top cover of the sauna room assembly of FIG. 1a.

FIGS. 9a and 9b are perspective views showing the assembly of the floor of the sauna room assembly of FIG. 1a.

FIGS. 10a˜10d are perspective views showing the assembly and installation of the door of the sauna room assembly of FIG. 1a.

FIG. 11 is a perspective view showing the installation of the seat of the sauna room assembly of FIG. 1a.

FIG. 12 is a perspective exploded view showing the various components of a conventional sauna room.

### DETAILED DESCRIPTION OF THE PREFERRED EMBODIMENTS

The following descriptions are of exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

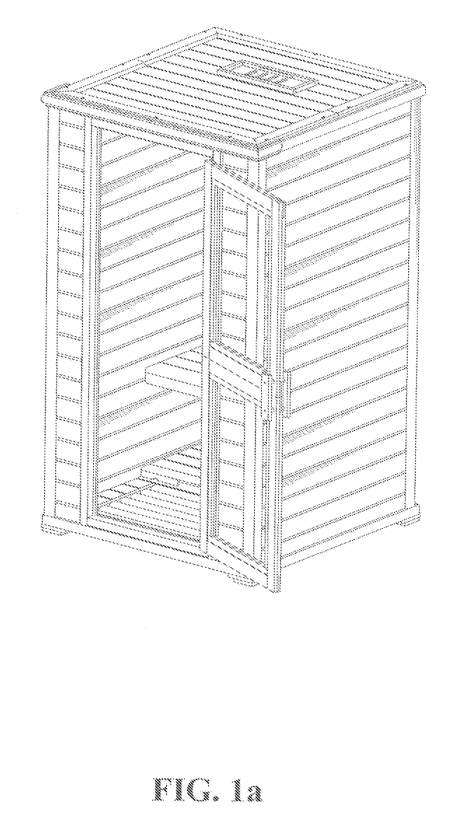

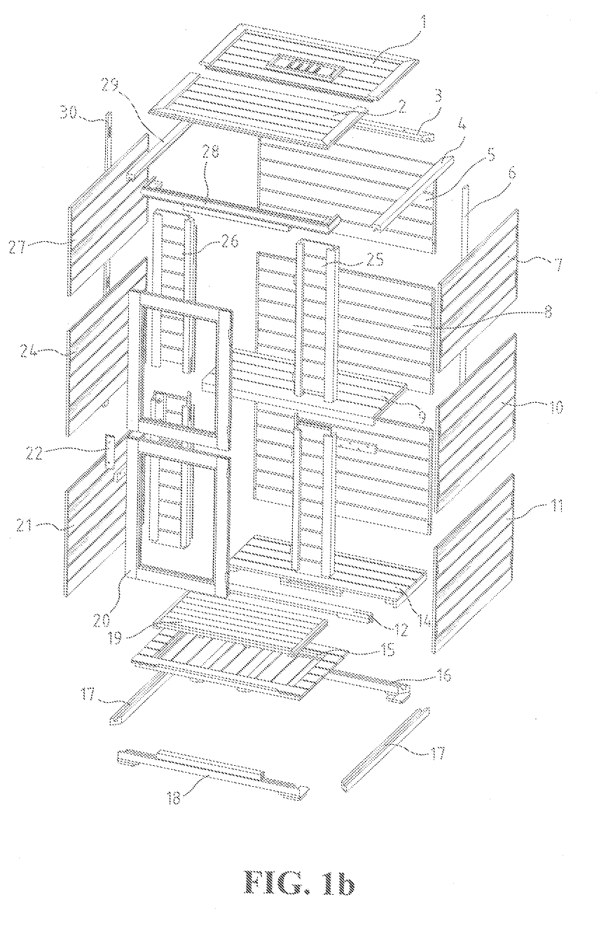

FIG. 1a is a perspective view showing a sauna room assembly according to an embodiment of the present invention while FIG. 1b is a perspective exploded view showing the various pieces of the sauna room assembly. The present embodiment is capable of accommodating up to two grown-ups and, by enlarging the pieces proportionally by their widths, the capacity can be increased to hold up in three or more adults. For both two-person and three-person sauna room assembly, real implementations of the present invention have shown that the pieces can be stored in three packages and the three packages can be easily carried by a standard-sized sedan (with one package in the trunk and two others inside the sedan), thereby achieving a high portability. The sauna room assembly of the present invention is designed to use electrical treating devices and a box-shaped electrical heating device is usually placed on the floor of the sauna room assembly. For simplicity and also as the electrical heating device is not a subject matter of the present invention, the electrical heating device is not shown in the accompanied drawings.

As illustrated in FIGS. 1a and 1b, the structure or the sauna room assembly is divided into a number of members including a bottom frame, left and right front walls, left and right back columns, left and right walls, a back wall, a top frame, a top cover, a floor, and a door. A major characteristic of the sauna room assembly is that each of the aforementioned members, usually made of woods, is in turn assembled by at least two pieces, and all pieces of the same member are of substantially identical dimension, thereby achieving a high portability. Please note that, in the following, all directional and positional references are made from the viewpoint of the sauna room assembly. Therefore, then the term top (or upper), bottom (or lower), front, back, left, right, inside (or inner), or outside (or external) is used, it is referred to facing the top, bottom, front, back, left, right, inside, or outside of the sauna room assembly.

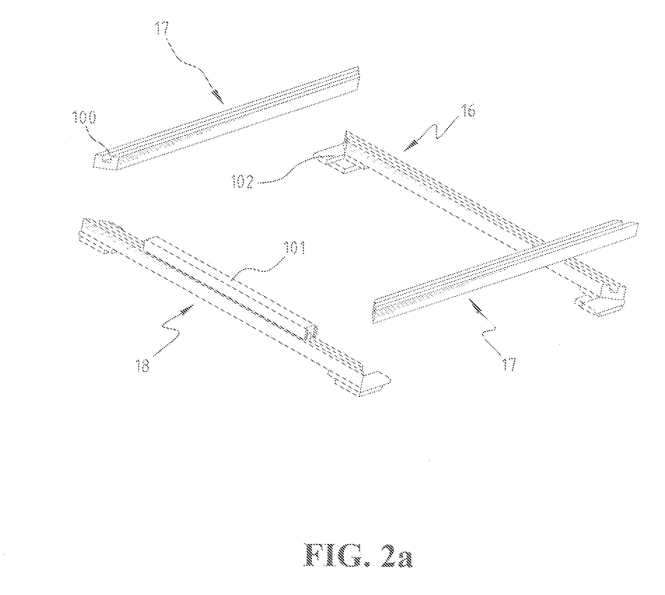

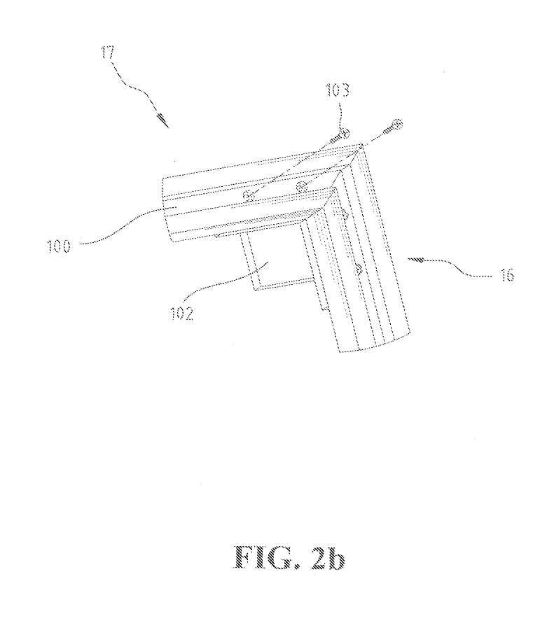

The rest of the drawings are perspective views showing the sequential steps of constructing the sauna room assembly of FIG. 1a with the pieces shown in FIG. 1b. As FIG. 2a shows, the bottom frame has a rectangular shape with a front fame segment 18, a back segment 16, and left and right segments 17, making up the four edges of the bottom frame, respectively. Each segment has triangle-shaped ends for joining with two other segments at right angles and, on the top side of each segment, there is an end-to-end ditch 100. Therefore, when the bottom frame is assembled, there is a rectangular ditch on the top side upon which the walls of the sauna room assembly are later raised. Please note that the left and right segments 17 are of substantially identical dimension (i.e., length, width, and height); and the front and back segments 16 and 18 are also of substantially identical dimension. A doorsill 101 can be further provided on top of a middle section of the front segment 18, separating the front segment 18's ditch 100 into a left section and a right section (both not numbered) for the installation of the left and right front walls, respectively (more details will be given later). Beneath each of the four corners of the bottom frame, there is an L-shaped stand 102. Each stand 102 has a leg of the L-shaped body beneath the front or back segment 18 or 16, and another leg beneath the left or right segment 17. To assembly the bottom frame, the four segments 16, 17, and 18 are pieced into the rectangular bottom frame and, as shown in FIG. 2b, a number of bolts 103 are driven through the ditches 100 at the two ends of the segments into the stands 102 below so as to fixedly join the segments 16, 17, and 18 together.

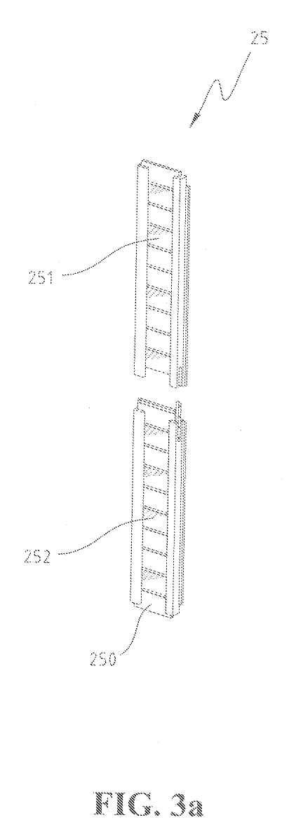

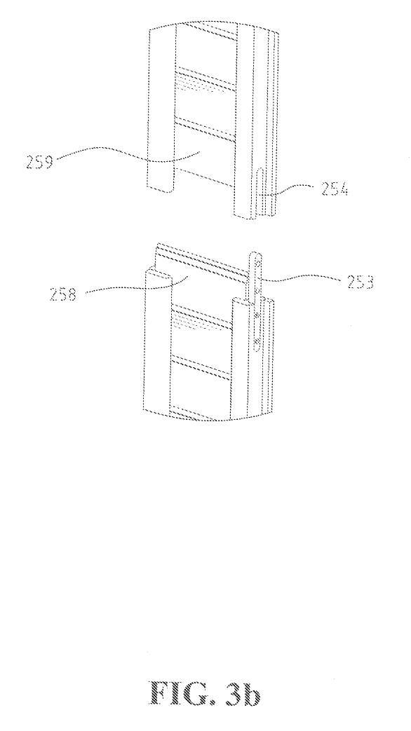

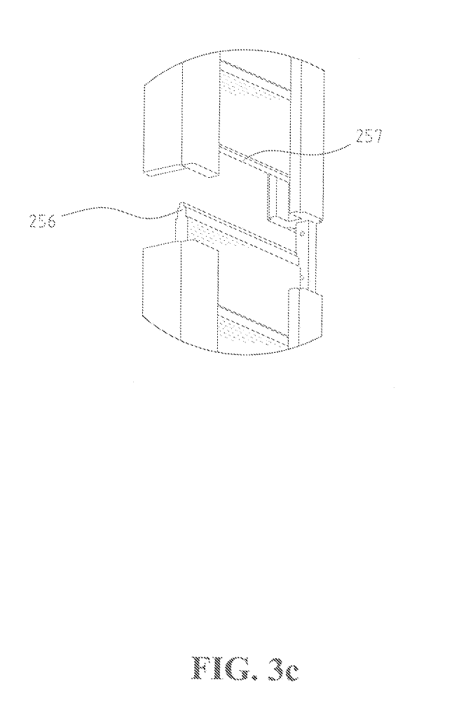

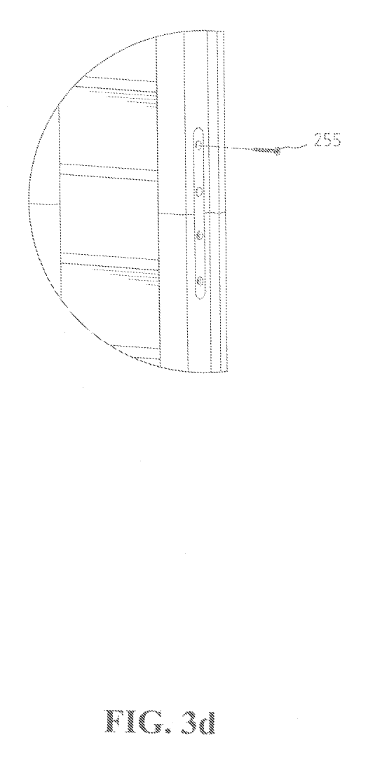

FIG. 3a shows how the left front wall 25 is put together. As illustrated, the left front wall 25 contains a rectangular upper wall board 251 and a rectangular lower wall board 252, joined together vertically. As shown in FIG. 3b, the lower wall board 252 has a top middle section 258 vertically extended over the top edge of the lower wall board 252; and the top middle section 258 has a ridge 256 (see FIG. 3c) along the top side of the top middle section 258. Correspondingly, the upper wall board 251 has a bottom middle section 259 receding from the bottom edge of the upper wall board 251; and the bottom middle section 259 has a groove 257 (see FIG. 3c) along the bottom side of the bottom middle section 259. The top and bottom wall boards 251 and 252 therefore can be vertically and tightly joined together by having the ridge 256 embedded into the groove 257. Please note that the lower wall boards 252 has a bottom middle section 250 (see FIG. 3a) extended downward over the bottom edge for an appropriate distance. As will be explained later, the bottom middle section 250 is for embedding into the left section of the ditch 100 of the front segment 18. However, as the ditch 100 is rather shallow compared to the height of the lower wall board 252, the upper and lower wall boards 251 and 252 can be considered to be of substantially identical dimension. As shown in FIG. 3b, to the left side of the upper and lower wall board 251 and 252, there are grooves 254 correspondingly and vertically provided on the bottom and top left sides of the wall boards 251 and 252, respectively. After the wall boards 251 and 252 are joined, an elongated bridging piece 253 (usually made of a metallic material) is positioned in the space jointly formed by the grooves 254 to bridge across the interface where the wall beams 251 and 252 are joined. Then, as shown in FIG. 3d, a number of bolts 255 are driven through the bolt holes (not numbered) on the bridging piece 253 so that the two wall boards 251 and 252 are locked reliably together.

The left and right front walls 25 and 26 are basically identical; therefore, the foregoing description about the assembly of the left front wall 25 and the details shown in drawings apply to the right front wall 26 as well. However, please note that the right front wall 26 has the bridging piece and the grooves provided on the right side of the right front wall 26.

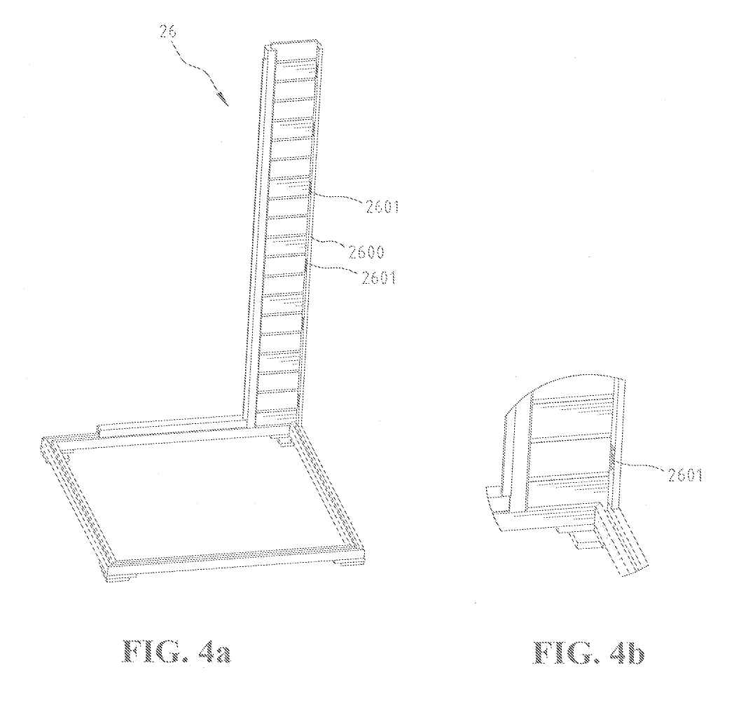

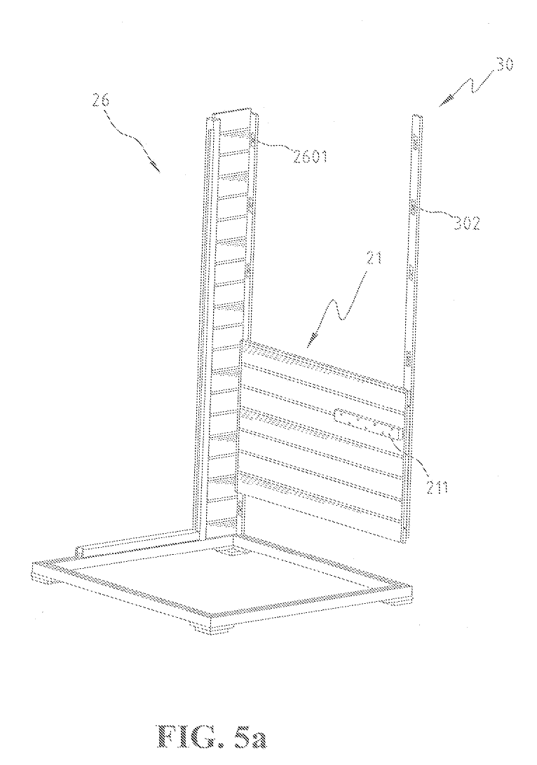

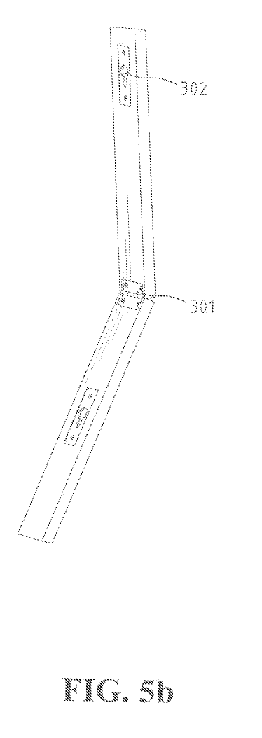

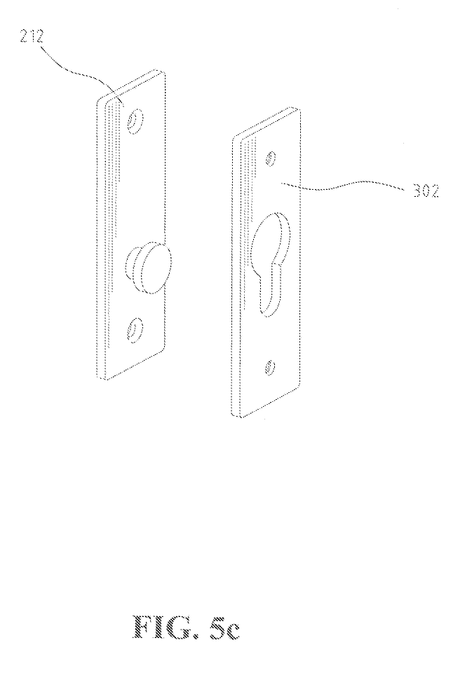

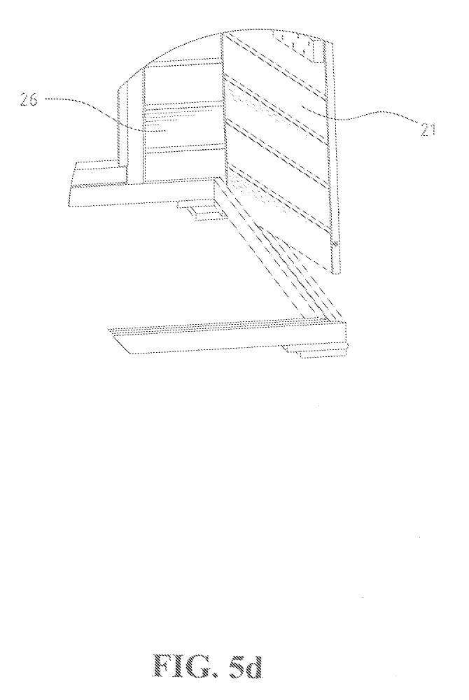

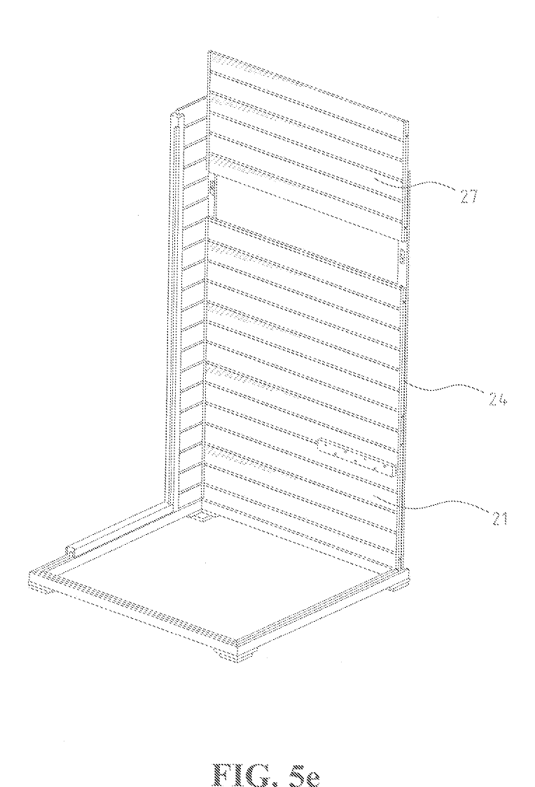

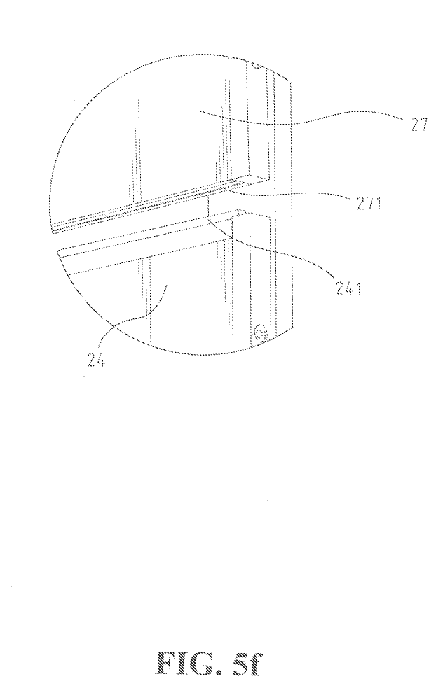

The installation of the right front wall 26 is illustrated in FIGS. 4a and 4b. As illustrated and as mentioned earlier, the right front wall 26 is raised on top of the bottom frame by having the bottom middle section embedded into the right section of the ditch 100 of the front segment 100. Please also note that both the upper and lower wall boards of the right front walls 26 have an edge-to-edge extension 2600 extended perpendicularly from their right side slightly towards the back, respectively. Along the inner side of the extensions 2600, there are a number of slotted plates 2601 properly spaced apart, which will be used later to join with the right wall. The slotted plates 2601 are the same as the slotted plates 302 shown in FIG. 5c. Similarly, as the left and right front walls 25 and 26 are basically identical, the foregoing description about the installation of the right front wall 26 and the details shown in the relevant drawings apply to the left front wall 25 as well. However, please note that the left front wall 25 has the edge-to-edge sections extended from its left side.

FIGS. 5a to 5f show the assembly and installation of the right back column 30 and the right wall. As illustrated in FIG. 5b, the right back column 30 contains two column segments (not numbered) of substantially identical dimension connected at their ends by a hinge 301 so that the right back column 30 can be folded and expanded. Along the inner side of the right back column 30, there are a number of slotted plates 302 identical to and arranged at substantially the same heights as the slotted plates 2601. The slotted plates 302 also will be used later for the installation the rigid wall.

As shown in FIG. 5e, the right wall is formed by stacking vertically the rectangular wall boards 21, 24, and 27 of substantially identical dimension from bottom to top. Along the left and right edge of the external side of the bottommost wall bound 21, there are a number of hooks 212 corresponding to the slotted plates 2601 and 302, respectively, as shown in FIG. 5c. The bottommost wall board 21 has its bottom edge embedded into the ditch 100 of the right segment 17 as shown in FIG. 5d and, in the meantime, its hooks 212 are locked to the slotted states 2601 and 302. The other wall boards 24 and 27 contain identical hooks so that they are installed following the same manner to complete the right wall. Please note that, for a wall board beneath (such as the wall board 24 shown in FIG. 5f) another one, there is a ridge (such as the ridge 241 shown in FIG. 5f) along its top side while the wall board above (such as the wall board 27 shown in FIG. 5f) has a groove (such as the groove 271 shown in FIG. 5f) along its bottom side. The two wall boards therefore can be vertically and tightly joined together. Please also note that, on the inner side of the bottommost wall board 21, there is a supporting stick 211 laterally arranged near the back wall as shown in FIG. 5a. This supporting stick 211 is for the installation or a seat board and more details will be given later.

The left back column 6 and the left wall boards 11, 10, and 7 are identical to the right back column 30 and the right wall boards 21, 24, and 27. Therefore, they can be assembled and installed following the same procedure as shown in FIGS. 5a and 5f. The details are omitted here for simplicity.

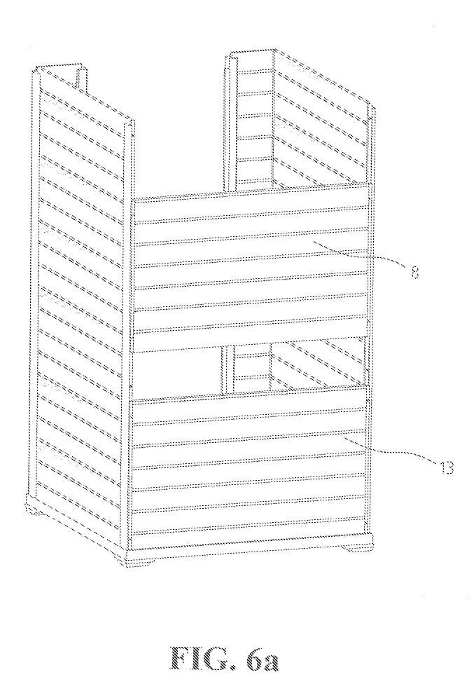

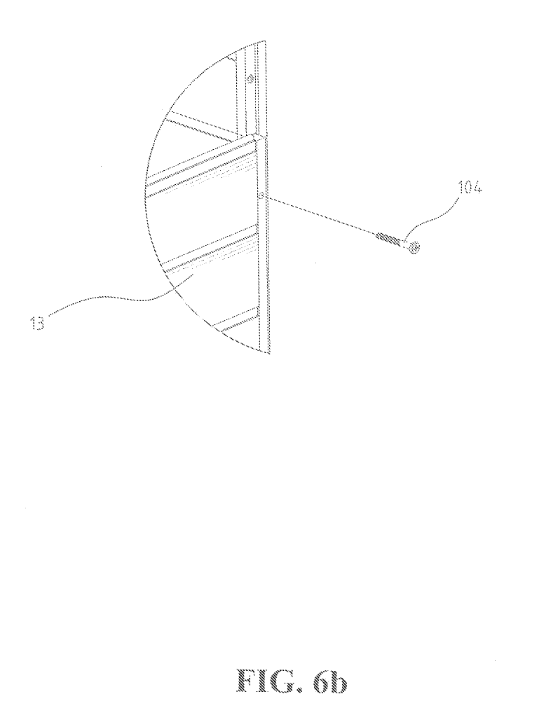

FIGS. 6a˜6c show the assembly and installation of the back, wall, which is also formed by stacking vertically three rectangular wall boards 13, 8, and 5 of substantially identical dimension from bottom to top. The bottom edge of the bottommost wall board 13 is embedded into the ditch 100 of the back segment 16 and, then, bolts 104 are driven through and along the left and right edges of the external side of the wall board 13 into the left and right walls, respectively, as shown in FIG. 6b. The other two wall boards 8 end 5 then sequentially stacked are bolted in the same manner to complete the back wall. Please note that, for a wall board beneath (such as the wall board 13 shown in FIG. 6c) another one, there is a ridge (such as the ridge 131 shown in FIG. 6c) along its top side while the wall board above (such as the wall board 8 shown in FIG. 6c) has a groove (such as the groove 81 shown in FIG. 6c) along its bottom side. The two wall boards therefore can be vertically and tightly joined together. Please note that, on the inner side of the bottommost wall beam 13, there is a supporting stick (not numbered, see FIG. 1b) laterally arranged in the middle. This supporting stick is also for the installation of the seat board. More details will be given later.

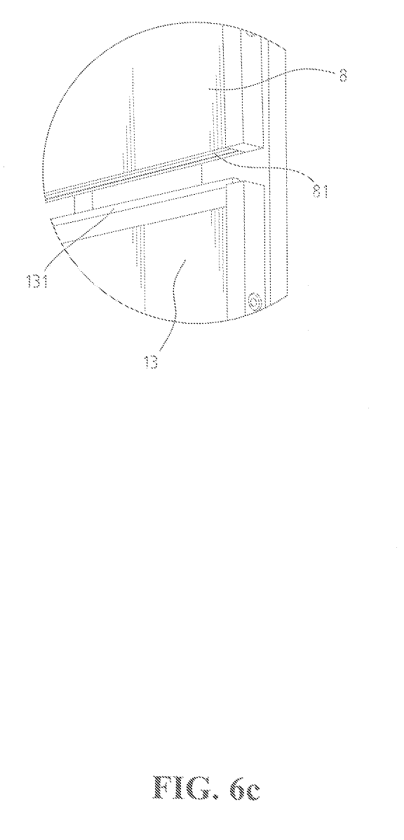

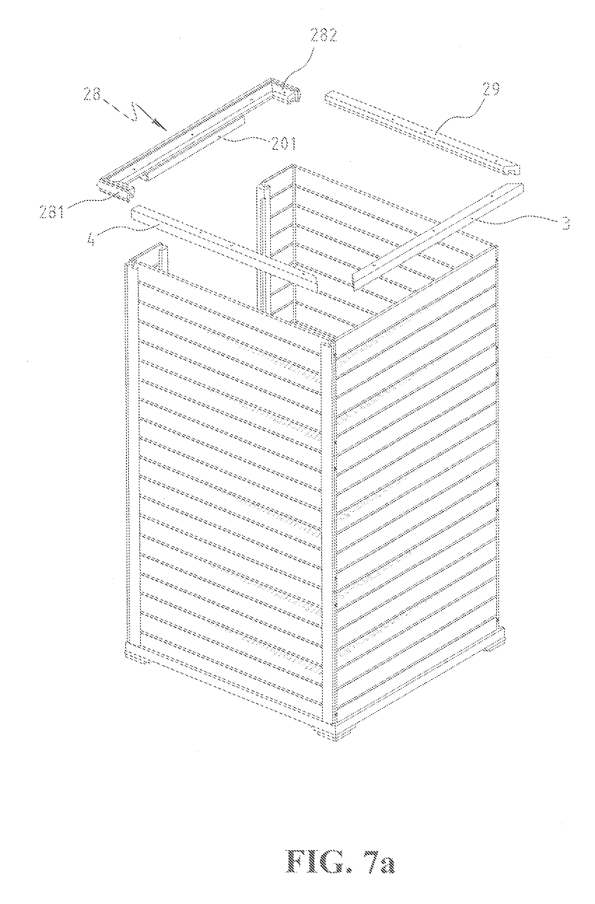

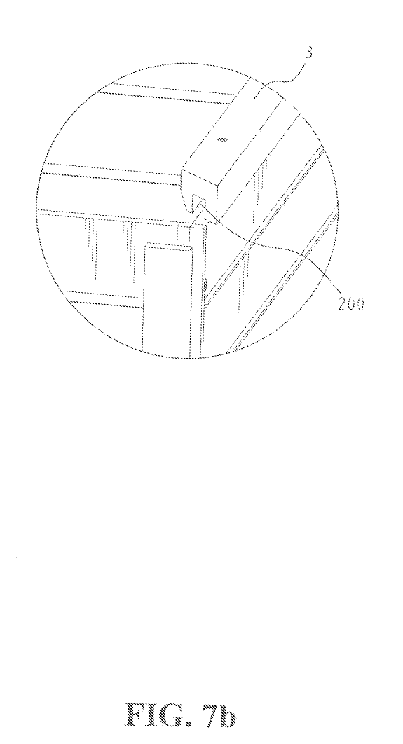

FIGS. 7a and 7b show the assembly and installation of the top frame. The top frame, similar to the bottom frame, has a rectangular shape with a front fame segment 28, a back segment 3, a left segment 4, and a right segments 29 making up the edges of the top frame,. However, unlike the bottom frame's front segment 18, the front segment 28 of the present embodiment has a U-like shape with two perpendicular legs 281 and 282 extended backward. The left and right segments 4 and 29 have a flat end and a triangular end, respectively. The flat ends interface with the two perpendicular legs 281 and 282 of the front segment 28 and the triangular ends, on the other hand, interface with the triangular ends of the back segment 3. On the bottom side of each segment, there is an end-to-end ditch 200 (the ditch 200 of the front segment 28 would have a U-like shape). The four segments are directly installed on top of the top edges of the walls. The legs 281 and 282 then would be on top of a top front section of the top edges of the left and right walls, respectively. The top edges of the walls are therefore embedded inside the ditches 200, respectively, as shown in FIG. 7b. Please note that the front and back segments 28 and 3 are of substantially identical length and height. The left and right segments 4 and 29 are of substantially identical dimension. As illustrated, a lintel 201 can be provided beneath a middle section of the front segment 28, right between the left and right front walls 25 and 26. Please note that, in some embodiment, the four segments of the top frame can be configured exactly like those of the bottom tissue (i.e., all with triangular ends).

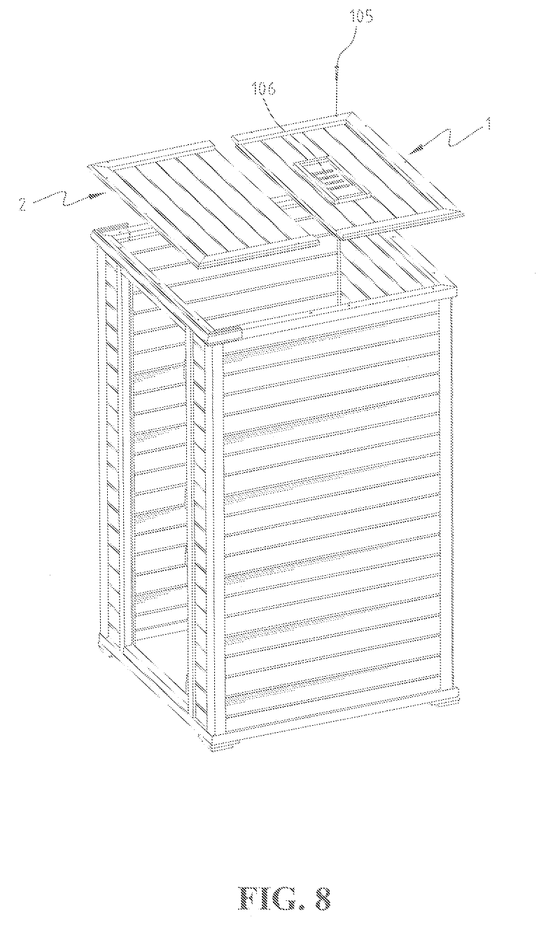

FIG. 8 shows the assembly and installation of the top cover, which contains a rectangular front cover board 2 and a rectangular back cover board 1 of substantially identical dimension laterally pieced together along the edges parallel to the door. Even though not shown in the drawings, the edges of the front and back cover boards 2 and 1 that interface with each other adopt the same tabling technique as used by the wall boards of the left and right front walls, the left and right walls, and the back wall. That is, a cover board has a ridge while the other has a groove along their interfacing sides, respectively. As such, the cover boards can be reliably and tightly pieced together. Then, bolts 105 are driven downward along the four edges of the top cover through the top segments into the top side of the walls. Please note that the back cover board 1 has a ventilator 106 for ventilation. In alternative embodiments, there can be no ventilator or the ventilator 106 is on the front cover board 2 instead. In some embodiments, it is also possible that the top cover contains a left cover board and a right cover board laterally pieced together along the edges perpendicular to the door.

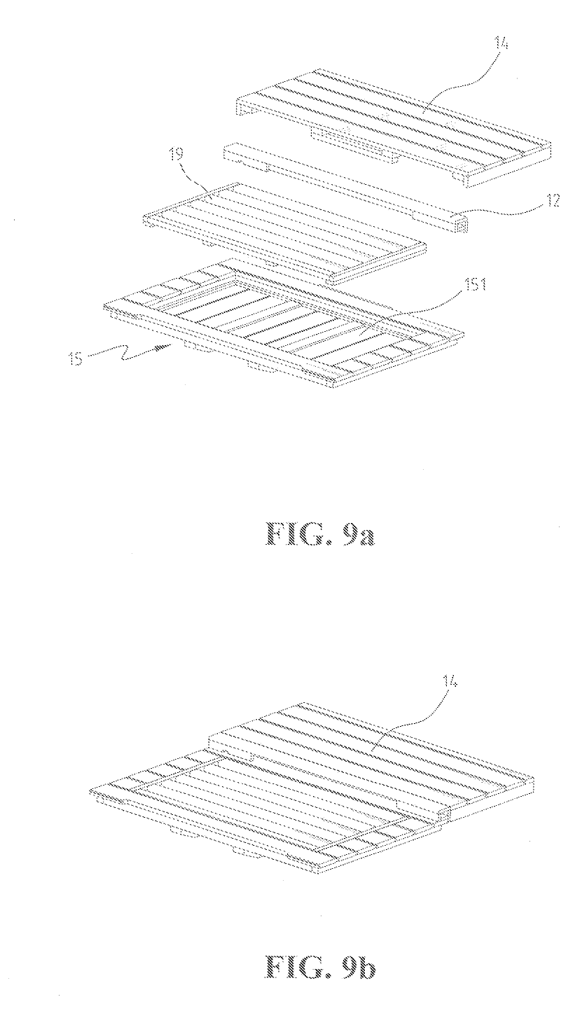

FIGS. 9a and 9b show the assembly of the floor. In its simplest form, the floor can contain two rectangular floor boards of substantially identical dimension pieced laterally together, just like the front and back cover boards 2 and 1 shown in FIG 8. In the present embodiment as shown in FIG. 9b, the floor contains a higher back floor board 14 and a lower front floor board (not numbered) of substantially equal length and width. As shown in FIG. 9a, the back floor board 14 is higher and a lighting device 12 (such as fluorescent lamp tube) is positioned along the front side of the back floor board 14 for illumination inside the sauna room assembly. On the other hand, the front floor board is lower and contains a front floor frame 15 with a central indentation 151, and a front floor cover 19 positioned over the indentation 151. The indentation 151 is for the installation of an electrical heating plate (not shown) for radiating heat through the front floor cover 19 into the sauna room assembly, in addition to a main electrical heating device (not shown) inside the sauna room assembly. Once the floor is assembled, it can be directly positioned within the bottom frame on the ground inside the sauna room assembly.

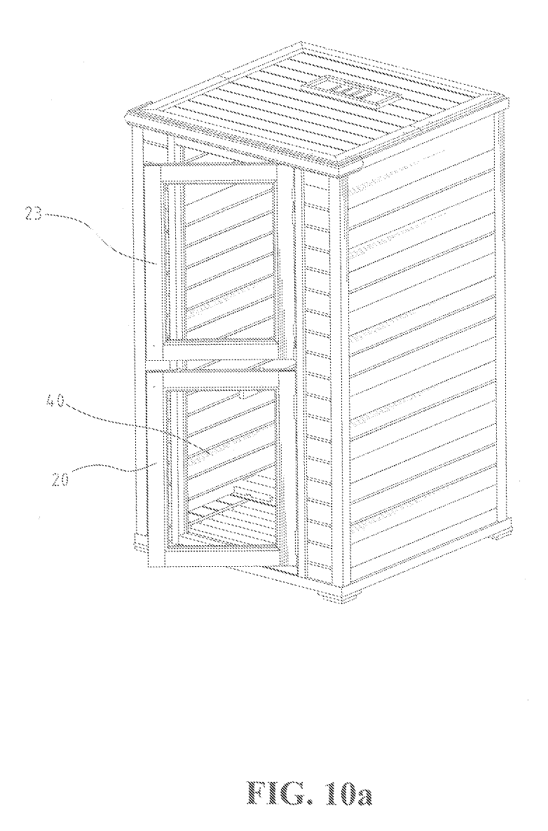

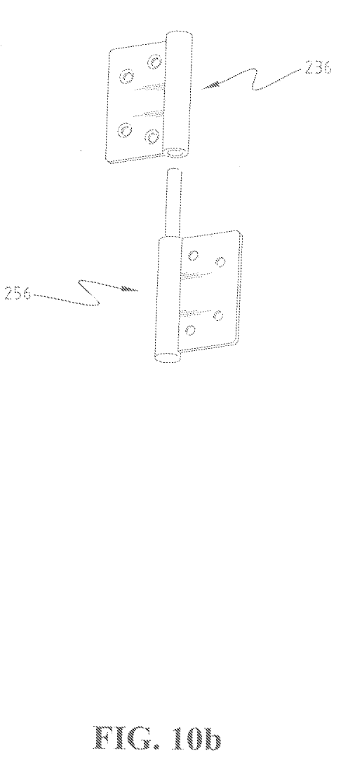

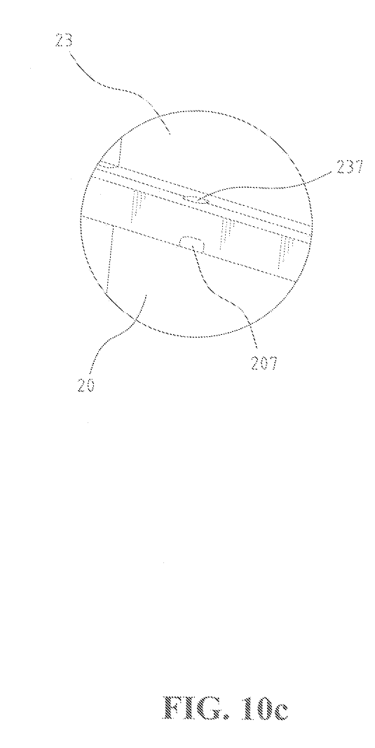

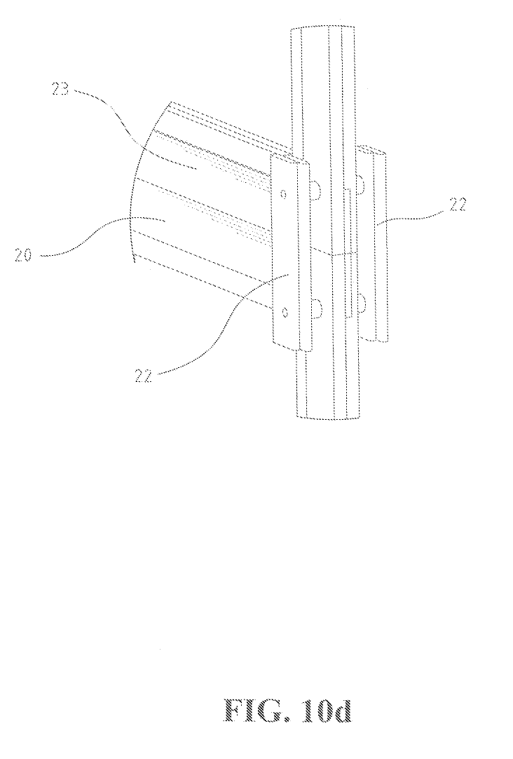

FIGS. 10a˜10d show the assembly and installation of the door. As illustrated in FIG. 10a, the door contains an upper door board 23 are a lower door board 20 of substantially identical dimension vertically stacked together. Each of the upper and lower door boards 23 and 20 has a transparent plate 40 (e.g., a piece of glass) in the middle. At least a hinge leaf (such as the hinge leaf with barrel 236 shown in FIG. 10b) is provided on the left side of the door boards 23 and 20, respectively. Correspondingly, a number of hinges leaves (such as the hinge leaf with pivot pin 256 shown in FIG. 10b) are provided along the right side of the left front wall 25. In alternative embodiments, the door boards 23 and 20 can have no transparent plate 40 or only one of the door boards 23 and 20 has the transparent plate 40. The upper and lower door boards 23 and 20 are installed by joining the corresponding hinge leaves together (e.g., by slipping the barrels of the hinge leaves 236 over the pivot pins of the corresponding hinge leaves 256). The upper end lower door boards 23 and 20 therefore can be swiveled open from right to left. Please note that the hinge leaves can also be installed along the right side of the door boards 23 and 20, and along the left side of the right front wall 26, respectively. Then, the upper and lower door boards 23 and 20 configured as such can be swiveled open from left to right.

To join the upper and lower door boards 23 and 20 together so that they can be turned together, the upper door board 23 has at least a tenon hole (such as the tenon hole 237 shown in FIG. 10c) on its bottom sale are the lower door board 20 has at least a corresponding tenon (such as the tenon 207 shown in FIG. 10c) on its top side. As the upper and lower door boards 23 and 20 are installed, the tenons 207 will be embedded into the corresponding tenon holes 237. Please note that, in an alternative embodiment, the tenon is on the upper door board while the tenon hole is on the lower door board. To further tie the upper and lower door boards 23 and 20 together, a front handle 22 and a corresponding back handle 22 are installed to the external side and the inner side of the door, respectively, close and parallel to the right edge of the door as shown in FIG. 10d. The handles 22 bridge across the interfacing edges of the upper end lower door boards 23 and 20. Then, bolts (not shown) are driven perpendicularly through the front handle 22, the door boards, and the back handle 22 to tie them securely together. Please note that, in alternative embodiments, it is possible to have only a front handle 22 or a back handle 22 installed. Also, if the door is configured to be swiveled open from left to right, the handles 22 are installed close and parallel to the left edge of the door.

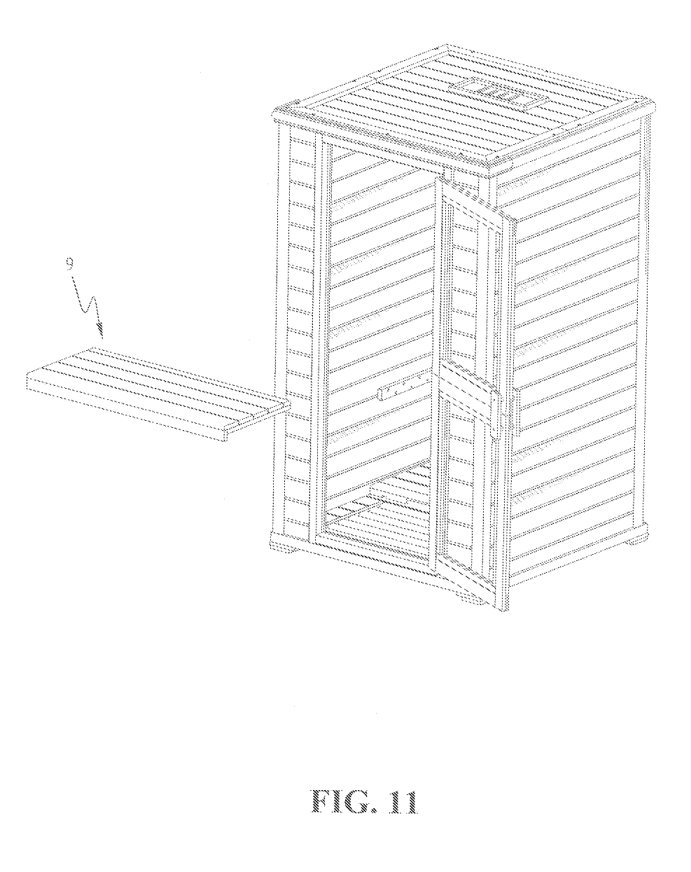

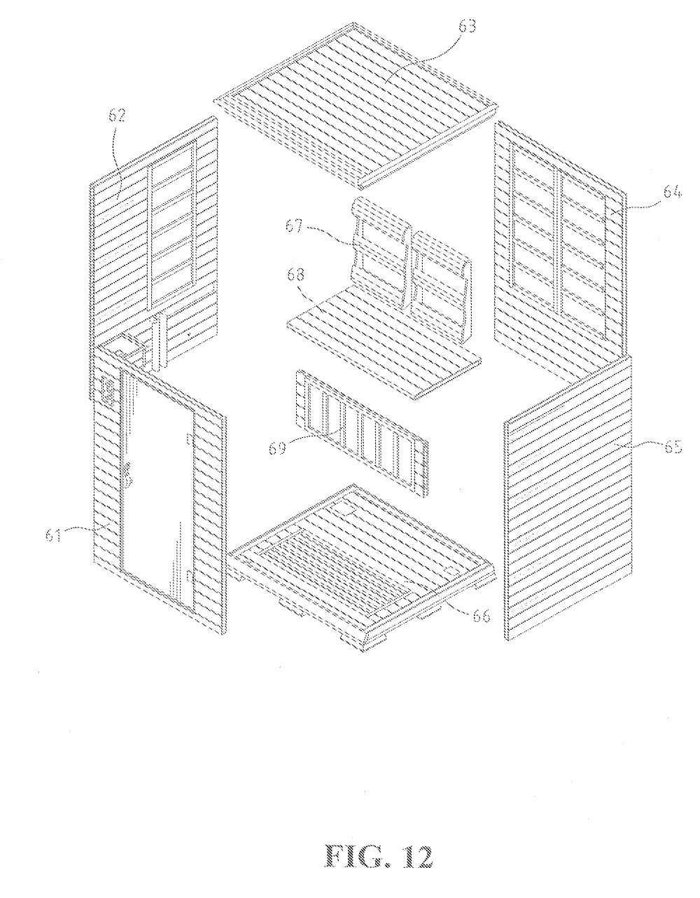

Finally, as shown in FIG. 11, a seat board 9 is positioned on the supporting sticks of the left, right, and back walls and the sauna room assembly is completed. To disassemble, the foregoing steps are conducted in the reversed order and therefore the details are omitted here. As mentioned earlier, the sauna room assembly described is designed to use electrical heating devices. The power cables to the electrical heating devices (such as the heating plate inside the floor), and the lighting device can be threaded through the bottom of the sauna room assembly and connected to wall outlets. Again, the electrical heating devices are not the subject matters of the present invention and, basically, any owe or more appropriate electrical heating devices can be adopted.

As described, the sauna room assembly of the present invention, in addition to the breaking down into smaller pieces for high portability, also enjoys the following advantages. First, most pieces of the sauna room assembly are joined together through tabling and only few bolts are required. Therefore, a single novice can put the sauna room assembly together with standard hand tools such as screwdrivers. In addition, most of the pieces have standardized shapes and dimensions such as the upper and lower door boards, the left, right, and back wall boards, etc. The manufacture of the sauna room assembly is therefore significantly simplified with few parts and the production cost is thereby reduced.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the spirit of the present invention.

I claim:

1. A portable sauna room assembly, comprising:
a rectangular bottom frame having a front segment, and a back segment of substantially identical dimension, and a left segment and a right segment of substantially identical dimension, making up the four edges of said bottom frame, wherein
each of said segments has an end-to-end ditch; and
said end-to-end ditches join into a rectangular ditch on a top side of said bottom frame;
a left front wall and a right front wall vertically standing on top of said front segment of said bottom frame, each having at least a rectangular lower wall board and a rectangular upper wall board of substantially identical dimension vertically stacked from bottom to top, wherein
said lower wall boards of said left and right front, walls have a bottom middle section embedded into a left section and a right section of said ditch of said bottom frame's said front segment, respectively;
each of said upper and lower wall boards of said left front wall has an edge-to-edge left extension perpendicularly extended slightly backward where a plurality of slotted plates are positions at appropriate spacing along an inner side of said left extension;
each of said upper and lower wall boards of said right front wall has an edge-to-edge right extension perpendicularly extended slightly backward where a plurality of slotted plates are positioned at appropriate spacing along an inner side of said right extension; and
one of said left and right front walls has a plurality of first hinge leaves positioned at appropriate spacing along a side facing the other front wall;
a foldable left back column and a foldable right back column vertically standing on top of a left back corner and a right back corner of said bottom frame, respectively, each having at least two column segments of substantially identical dimension joined by a hinge, wherein a plurality of slotted plates are positioned along an inner side of said left and right back columns at substantially the same heights corresponding to said slotted plates of said left and right front walls, respectively;
a left wall and a rigid wall vertically standing on top of said left and right segments of said bottom frame, respectively, each having at least a rectangular lower wall board, a rectangular middle wall board, and a rectangular upper wall board of substantially identical dimension vertically stacked from bottom to top, wherein
said lower wall boards of said left and right walls have a bottom edge embedded into said ditches of said bottom frame's said left and right segments, respectively; and
a plurality of hooks are positioned along a left edge and a right edge on an external side of said upper, middle, and lower wall boards of said left and right walls, respectively;
said hooks of said left wall lock to said slotted plates of said left front wall and said left back column; and
said hooks of said right wall lock to said slotted plates of said right front wall and said right back column;
a back wall vertically standing on top of said back segment of said bottom frame having at least a rectangular lower wall board, a rectangular middle wall board, and a rectangular upper wall board of substantially identical dimension vertically stacked from bottom to top, wherein
said lower wall board of said back wall has a bottom edge embedded into said ditch of said bottom frame's said back segment; and
a plurality of bolts are driven along a left edge and a right edge on an external side of said upper, middle, and lower wall boards of said back wall into said left and right walls, respectively;
a rectangular top frame on top of said left and right front wall, said left and right walls, and said back ball, having a front segment and a back segment of substantially identical length and height, and a left segment and a right segment of substantially identical dimension, making up the four edges of said top frame, wherein
each of said segments of said top frame has on a bottom side an end-to-end ditch; and
each of said left and right front walls, said left and right walls, and said back wall has a top edge embedded into said ditches of said segments of said top frame, respectively;
a top cover on top of said top frame having a rectangular first cover board and a rectangular second cover board of substantially identical dimension laterally joined together;
a floor on the ground inside said sauna room assembly within said bottom frame having a rectangular first floor board and a rectangular second floor board of substantially identical length and width laterally joined together; and
a door having at least an upper door board sad a lower door board of substantially identical dimension vertically stacked together, wherein
at least a second hinge leaf is positioned along one of a left side and a right side of said upper and lower door boards at appropriate spacing for joining with said first hinges leaves of said left or right front walls;
wherein between two adjacent wall boards, a first ridge is positioned along an interfacing side of a wall board and a first groove is positioned along an interfacing side of the other wall board for the embedment of said first ridge; and, between two adjacent cover boards, a second ridge is positioned along an interfacing side of a cover board and a second groove is positioned along an interfacing side of the other cover board for the embedment of said second ridge.

2. The sauna room assembly according to claim 1, wherein a doorsill is on top of a middle section of said front segment of said bottom frame and between said left and right front walls.

3. The sauna room assembly according to claim 1, wherein four stands are beneath the four corners of said bottom frame, respectively.

4. The sauna room assembly according to claim 1, wherein a bridging piece is vertically positioned along a bottom left side of said upper wall board and an upper left side of said lower wall board of said left front wall across the interface where said upper and lower wall boards of said left front wall are joined.

5. The sauna room assembly according to claim 4, wherein said bridging piece is embedded in a space jointly formed by two grooves correspondingly and vertically positioned on said bottom left side of said upper wall board and said upper left side of said lower wall board of said left front wall, respectively.

6. The sauna room assembly according to claim 1, wherein a lintel is beneath a middle section of said front segment of said top frame and between said left and right front walls.

7. The sauna room assembly according to claim 1, wherein said front segment of said top frame has a U-like shape with two perpendicular legs interfacing with said left and right segments of said top frame, respectively, and positioned on top of a top front section of said top edges of said left and right walls, respectively.

8. The sauna room assembly according to claim 1, wherein at least one of said first and second cover boards has a ventilator.

9. The sauna room assembly accord to claim 1, wherein said first and second cover boards are joined at edges parallel to said door.

10. The sauna room assembly according to claim 1, wherein said first and second floor boards are joined at edges parallel to said door.

11. The sauna room assembly according to claim 1, wherein one of said first and second hinge leaves has a pivot pin and a corresponding hinge leaf has a barrel for joining with said pivot pin.

12. The sauna room assembly according to claim 1, wherein said second floor board is higher than said first floor board.

13. The sauna room assembly according to claim 12, further comprising a lighting device positioned along a front side of said second floor board.

14. The sauna room assembly according to claim 13, wherein said lighting device is a fluorescent lamp tube.

15. The sauna room assembly according to claim 1, wherein said first floor board contains a floor frame having an indentation and a floor cover positioned over said indentation.

16. The sauna room assembly according to claim 15, further comprising an electrical heat plate positioned inside said indentation.

17. The sauna room assembly according to claim 1, further comprising a seat board; wherein
an inner side of each of said lower wall boards of said left and right walls has a supporting sticks laterally positioned near said back wall; and
said seat board is positioned on top of said supporting sticks.

18. The sauna room assembly according to claim 1, wherein at least a tenon and at least a tenon hole are positioned at corresponding locations along the interfacing sides of said door boards, respectively.

19. The sauna room assembly according to claim 1, wherein at least one of said upper and lower door boards has a transparent plate for seeing through said door board.

20. The sauna room assembly according to claim 1, wherein a handle is positioned on one of an external side and an inner side of said door, bridging vertically across said upper and lower door boards, and adjacent and parallel to a right side of said door.
